(19) United States
(12) Patent Application Publication
(10) Pub. No.: US 2016/0167626 A1
(43) Pub. Date: Jun. 16, 2016

(54) RETRACTABLE VEHICLE JACK

(71) Applicants: Mohammed Alnemari, Denver, CO (US); Mohamed Idris, Columbus, OH (US)

(72) Inventors: Mohammed Alnemari, Denver, CO (US); Mohamed Idris, Columbus, OH (US)

(21) Appl. No.: 14/571,455

(22) Filed: Dec. 16, 2014

(51) Int. Cl. B60S 9/04

(52) U.S. Cl. CPC B60S 9/04

(57) ABSTRACT

A retractable vehicle jack mounted to a vehicle comprising a jack attached to an undercarriage of a vehicle, where the jack moves from an extended position and a retracted position; a top side of the jack, where the top side of the jack presses against the undercarriage of the vehicle when in the extended position; and a bottom side of the jack, where the bottom side of the jack presses against the ground when in the extended position. The jack may be positioned between the front door and the rear door for an optimal balance point on the vehicle.

### BACKGROUND OF THE INVENTION

1. Field of the Invention

The present invention relates to a vehicle jack that is mounted beneath a vehicle and extended whenever needed to assist extracting the vehicle from difficult terrain.

2. Description of Related Art

Car jacks and lifts are common tools used to elevate a vehicle. They may lift the entire car from the ground or simply a side or tire to enable repairs and quick fixes. Many recreational car jacks are stored within the trunk and rarely used but for tire changes and easy repairs. Industrial or professional lifts may elevate the entire car to allow for mechanic to make any repairs from beneath the vehicle. Alternatively, the jacks may also be used to provide traction and lift when a vehicle is stuck in mud or snow. The little bit of additional traction gained by lifting one of the wheels may all that is required to free the vehicle from the hazardous terrain.

Typically the lifts are used by first retrieving them from their storage location and then positioning them beneath the vehicle. The lift is then cranked or pumped to initiate raising the vehicle to the desired height. Once the vehicle is positioned, the person may perform their repairs. After finishing the vehicle is lowered by releasing the lift. The lift may then be stored until the next use. A single person may perform the job but it is typically easier with two. Also, when dislodging a vehicle from mud or snow one person must be in the vehicle to drive while the other waits to collect the jack. This is dangerous for the person outside the vehicle because the vehicle or lift may slide causing harm to all parties.

Therefore it would be desirable in the art to provide a vehicle jack that assists to release a vehicle from mud, sand or snow. It would also be beneficial in the art to provide a jack that is combined with the vehicle so that a single user may easily use the jack alone.

### SUMMARY OF THE INVENTION

In view of the foregoing disadvantages inherent in the prior art, the general purpose of the present invention is to provide a retractable vehicle jack mounted to the undercarriage of a vehicle, configured to include all of the advantages of the prior art, and to overcome the drawbacks inherent therein.

Accordingly, an object of the present invention is to provide a retractable vehicle jack that is mounted to and extends from the undercarriage of a vehicle.

Another object of the present invention is to provide a retractable vehicle jack with a control panel that allows for operation of the jack from within the vehicle.

To achieve the above objects, in an aspect of the present invention, a retractable vehicle jack is described comprising a jack attached to an undercarriage of a vehicle, where the jack moves from an extended position and a retracted position; a top side of the jack, where the top side of the jack presses against the undercarriage of the vehicle when in the extended position; and a bottom side of the jack, where the bottom side of the jack presses against the ground when in the extended position. The jack may be positioned between the front door and the rear door for an optimal balance point on the vehicle.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a retractable vehicle jack in accordance with an exemplary embodiment of the present invention; and

FIG. 2 depicts a perspective view of a retractable vehicle jack in a retracted position in accordance with an exemplary embodiment of the present invention.

Like reference numerals refer to like parts throughout the description of several views of the drawings.

### DETAILED DESCRIPTION OF THE DRAWINGS

The present invention relates to a vehicle jack that is mounted beneath a vehicle and extended whenever needed to assist extracting the vehicle from difficult terrain. The present invention provides a retractable vehicle jack to facilitate the process of dislodging vehicles from fine sand, muddy or snowy surfaces. The retractable vehicle jack is mounted on a side of the vehicle, between the doors. Within the vehicle is a control panel which activates and controls the movement of the retractable vehicle jack. During use, a user is able to extend the retractable vehicle jack without exiting their vehicle allowing for a single person vehicle lifting system.

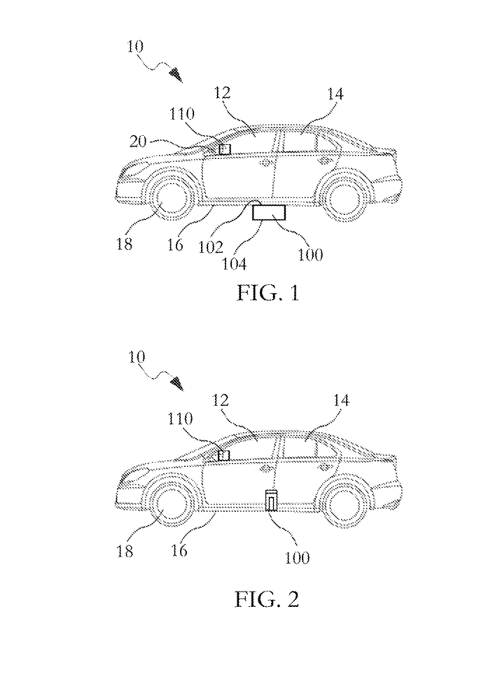

Turning now descriptively to the drawings, referring to FIG. 1, a retractable vehicle jack 100 is shown in accordance with an exemplary embodiment of the present invention. The retractable vehicle jack 100 is mounted to a vehicle 10. The vehicle 10 may be a car, truck, SUV, station wagon or the like. The retractable vehicle jack 10 is positioned between a front door 12 and a rear door 14 at an optimal balance point in the middle of the vehicle 10. If the vehicle 10 does not have a rear door 14, the retractable vehicle jack 10 may be mounted towards a rear portion of the front door 12 to provide the optimal balance. The retractable vehicle jack 100 is coupled to the undercarriage 16 of the vehicle 10 in a manner as to not interfere with door function, passenger comfort, engine function or a plethora of other vehicle operations.

As illustrated in FIG. 1, the retractable vehicle jack 100 is in an extended position. A top side 102 of the retractable vehicle jack 100 is flush against the undercarriage 16. A bottom side 104 is pressed against the ground until the tires 18 are able to dislodge themselves from the unstable terrain. The bottom side 104 is wide and flat to provide a large surface area that presses against the ground thereby facilitating vehicle traction to extract the vehicle 10 from the loose sand or mud. The retractable vehicle jack 100 is coupled to the vehicle battery to power the movement of the jack 100 during use.

Within the vehicle cabin, preferably attached to the dashboard 20, is a control panel 110. The control panel 110 manually operates the retractable vehicle jack 100 to activate and maneuver the jack 10 in times of need. The control panel 110 allows a single user to easily lift and then drive the vehicle 10 without additional assistance. Once the vehicle 10 is lifted; the user may then retract the retractable vehicle jack 100 as illustrated in FIG. 2. The retractable vehicle jack 100 is completely enveloped by the vehicle 10 so that nothing is exposed and will not interfere with normal driving. The control panel 110 may include a lock button which locks the retractable vehicle jack 100 in place to ensure safety while driving. With the retractable vehicle jack 100 the user is able to handily extract their vehicle after getting stuck in mud, sand or snow without requiring a tow or other vehicle to pull the vehicle out.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A retractable vehicle jack mounted to a vehicle comprising:
a. a jack attached to an undercarriage of a vehicle, where the jack moves from an extended position and a retracted position and said jack is placed at a balance point along a first side of the vehicle;
b. a top side of the jack, where the top side of the jack presses against the undercarriage of the vehicle when in the extended position; and
c. a bottom side of the jack, where the bottom side of the jack presses against the ground when in the extended position.

2. The retractable vehicle jack according to claim 1, where the bottom side is flat and wide to create a large surface area to press against the ground.

3. (canceled)

4. The retractable vehicle jack according to claim 1, where the jack includes a control panel attached to a dashboard of the vehicle within the vehicle cabin, where the control panel activates the jack to move between the extended and retracted positions.

5. (canceled)

6. (canceled)
